(19) United States
(12) Patent Application Publication
(10) Pub. No.: US 2009/0277827 A1
(43) Pub. Date: Nov. 12, 2009

(54) Liquids rebalancer

(76) Inventor: Alice Reid Galassi, Madison, WI (US)

Correspondence Address: ALICE GALASSI, APT 2-368, 2701 UNIVERSITY AVENUE, MADISON, WI, 53705, US

(21) Appl. No.: 12/152,075

(22) Filed: May 12, 2008

(51) Int. Cl. B01D 35/00

(52) U.S. Cl. 210/458

(57) ABSTRACT

A liquid rebalancer for improving the taste of liquids using a sinusoidal helical coil made of three-strand copper wire.

### BRIEF SUMMARY OF INVENTION

Application No: 12/152,075 Art Unit: 2831

The invention is a device to rebalance liquids, such as ordinary tap water, in order to improve the taste and remove dissolved gases and other impurities.

### BACKGROUND OF INVENTION

The deterioration of the municipal water supply led to a series of experiments using helically-coiled twisted wires for the purpose of improving the water quality. It was found that the water and other liquids, when placed in a bottle surrounded by these copper wires, had a smoother and more agreeable taste. At first, simple loops of wire were tried but without success. Then it was discovered that two or more wires, when twisted together in the form of a circular helical coil produced the desired effect. At the moment the exact theory of the phenomenon is unknown other than through extensive experimentation and taste testing.

### SUMMARY OF INVENTION

It is the object of this invention to produce better quality and better tasting water and other liquids, such as orange juice, through the use of multiple strands of copper wire that have been twisted together and shaped into a helical coil. The coil is then mounted between two plastic tubes and formed into a circular sinusoidal path. The structure is held together on both top and bottom by hollow circular plastic end caps. This allows the bottle containing the liquid to be inserted into the opening in the middle of the device.

### A BRIEF DESCRIPTION OF THE DRAWINGS

FIG. 1. Perspective exploded view of invention.

### DETAILED DESCRIPTION OF INVENTION

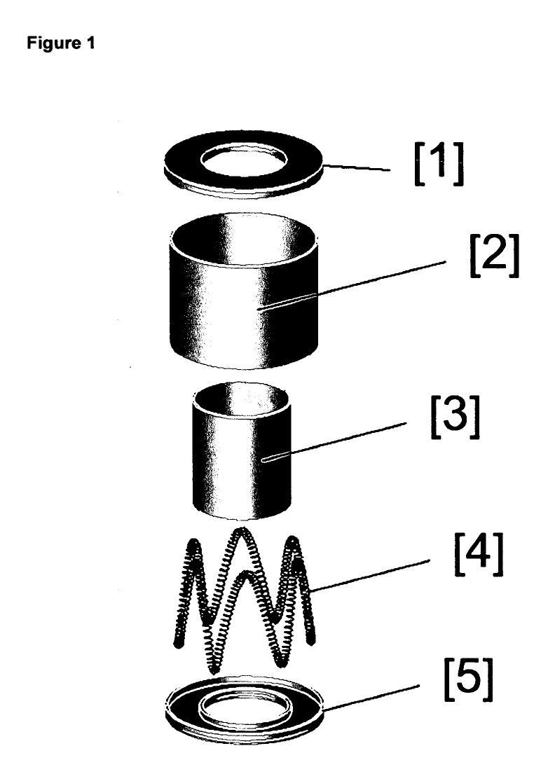

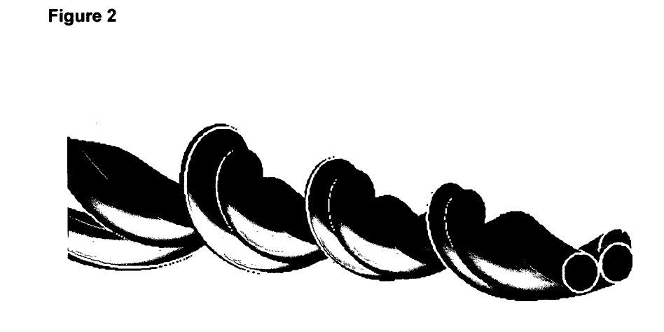

1. Referring to exploded view FIG. 1, the invention consists of a thin-walled outer plastic tube [2], a similar inner tube [3], the sinusoidal helical coil made of three twisted 18-gauge solid copper wires [4], the top hollow cap [1] and the bottom hollow cap [5] for keeping the tubes in place. The central opening is large enough to accommodate a glass bottle filled with the desired liquid.

What I claim as my invention is:

1. A liquids rebalancer having:
(a) inner and outer concentric tubes, preferably thin-walled plastic;
(b) a helical-coil embedded between the tubes (1a) along a path which is preferably sinusoidal around the circumference;
(c) a coil (1b) consisting of a plurality of wires, preferably three, made of solid copper, preferably 16 to 18 gauge; and
(d) two end caps with an opening in the center in order to hold the tubes (1a) together.
